(19) United States
(12) Patent Application Publication
(10) Pub. No.: US 2021/0408684 A1
(43) Pub. Date: Dec. 30, 2021

(54) A Planar Loop Antenna, Its Applications and Application Methods

(71) Applicant: Innovation Sound Technology Co., LTD., Guangdong (CN)

(72) Inventors: Shunming YUEN, Guangdong (CN); Wai Yin MUNG, Guangdong (CN); Ka Ming WU, Guangdong (CN)

(21) Appl. No.: 16/611,152

(22) PCT Filed: Oct. 25, 2018
(86) PCT No.: PCT/CN2018/111922

§ 371 Date: Nov. 5, 2019

(30) Foreign Application Priority Data
Oct. 22, 2018 (CN) 201811231147.6

(51) Int. Cl. H01Q 5/307; H01Q 1/38; H01Q 7/00; H01Q 1/48

(52) U.S. Cl. CPC H01Q 5/307; H01Q 1/48; H01Q 7/00; H01Q 1/38

(57) ABSTRACT

The Invention discloses a planar loop antenna, its applications and application methods, which comprises a PCB, a ground plane and a plane antenna. The said ground plane and the plane antenna are fixed on the PCB, and a rectangular cavity is disposed in the center of the plane antenna. The loop antenna proposed in the present invention, by adjusting the lengths of L1 and L2, obtains different operating frequencies, and meets the use of different antenna products. In addition, the present invention is able to support a spectrum system within 1.5-2.6 GHz and a higher LTE spectrum within 3.3-3.9 GHz by adjusting L1 and L2.

### FIELD OF THE INVENTION

The present invention relates to the field of communication technologies, and in particular to a planar loop antenna, its applications and application methods.

### BACKGROUND OF THE INVENTION

The Internet of Things (IoT) refers to the interconnection and exchange of data between devices/sensors. At present, with the explosive growth of Internet of Things technology, more and more practical applications can be found in many fields, including security, asset tracking, agriculture, smart metering, smart city and smart home. IoT applications have specific requirements such as long distances, low data rates, low power consumption and cost effectiveness. Widely-used short-range radio technologies (e.g., ZigBee, Bluetooth) are not suitable for scenarios that require a long-distance transmission. Solutions based on cellular communications (e.g., 2G, 3G, and 4G) can provide a greater coverage, but they consume excessive device power.

Therefore, the current solution is to integrate various short-range radio technologies (e.g., ZigBee, Bluetooth, and cellular communications (e.g., 2G, 3G, and 4G)) for use. As a consequence, a broadband antenna is required for the communication between the above two types of technologies, and also for external transmission and reception.

### DESCRIPTION OF THE INVENTION

The present invention aims to provide a planar loop antenna, its applications and application methods to solve the problems brought up in the above background technology.

To achieve the above object, the present invention provides the following technical schemes:

A planar loop antenna, its applications and application methods, which comprises a PCB, a ground plane and a plane antenna, wherein the said ground plane and the plane antenna are fixed on the PCB, and a rectangular cavity is disposed in the center of the plane antenna.

As a further scheme of the invention, an electronic circuit is disposed at the bottom of the said ground plane.

As a further scheme of the invention, the distance between the said plane antenna and the PCB is 1 mm.

A planar loop antenna, its applications and application methods, as well as its applications in LTE communication in 3.3 to 3.9 GHz band, and in Bluetooth communication.

A planar loop antenna, its applications and application methods, wherein different antenna operating frequencies are obtained by adjusting the distance between the short side of the cavity and the plane antenna.

Compared with the prior art, the beneficial effect of the present invention is as follows:

The loop antenna proposed in the present invention, by adjusting the lengths of L1 and L2, obtains different operating frequencies, and meets the use of different antenna products. In addition, the present invention is able to support a spectrum system within 1.5-2.6 GHz and a higher LTE spectrum within 3.3-3.9 GHz by adjusting L1 and L2.

### BRIEF INTRODUCTION OF THE DRAWINGS

FIG. 1 is a structural schematic diagram of a planar loop antenna, its applications and application methods.

FIG. 2 is a simulation result diagram of antenna A1 and antenna A2.

FIG. 3 is a simulation result diagram of antenna B1 and antenna B2.

FIG. 4 is a test result diagram of antennas A1, A2, B1, and B2.

### DETAILED EMBODIMENT

The technical scheme in the embodiment of the present invention will be clearly and completely described as follows with reference to the accompanying drawings. Apparently, the described embodiments are only a part of that of the invention, and not all of them. All other embodiments obtained by those skilled in the art based on the embodiments of the present invention without making creative efforts shall fall within the scope of protection of the present invention.

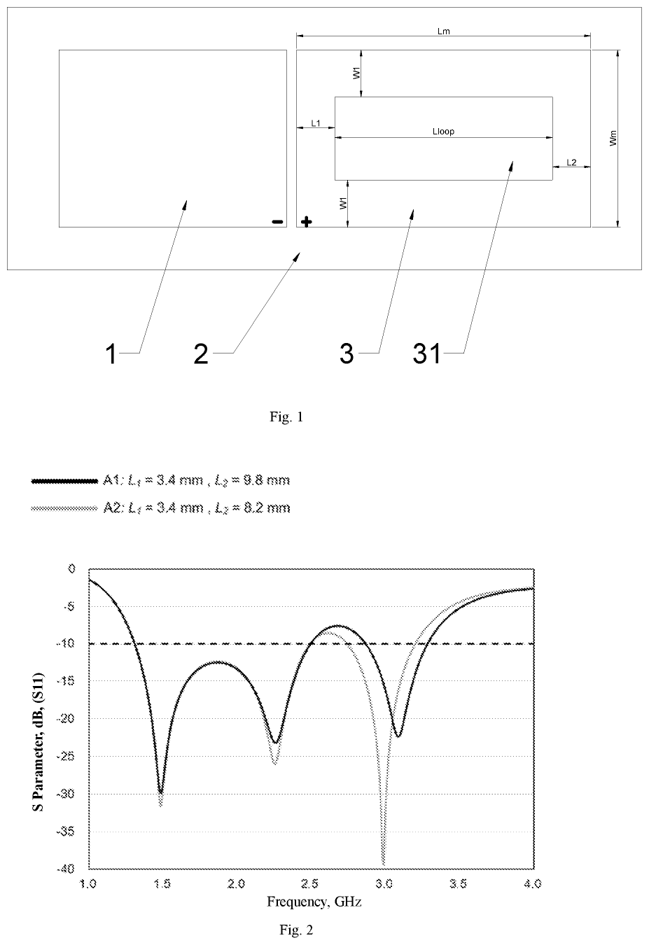

FIG. 1 shows a planar loop antenna, its applications and application methods, which comprise a PCB 2, a ground plane 1 and a plane antenna 3. The said ground plane 1 and the plane antenna are fixed on the PCB 2, and the central portion of the plane antenna 3 is provided with a rectangular cavity 31, which makes the plane antenna 3 annular.

The plane antenna 3 has a size of Wₘ×Lₘ=25 mm×46 mm, and the distance between the long side of the rectangular cavity 31 and the long side of the plane antenna 3 is W₁=5.6 mm. Changing the distance between the two short sides of the cavity 31 and the two short sides of the plane antenna 3, i.e., the length of L1 and L2, causes different changes in the operating frequency of the antenna.

### Embodiment 1

With L1=3.4 mm and L2=9.8 mm for antenna A1, and L1=3.4 mm and L2=8.2 mm for antenna A2, FIG. 2 shows the simulation results of antenna A1 and antenna A2. It can be seen that changing the length of L2 causes the length (Lₗₒₒₚ) of the cavity 31 to decrease, and the feedback loss of the antenna, i.e., the resonant frequency of the antenna, gets higher;

### Embodiment 2

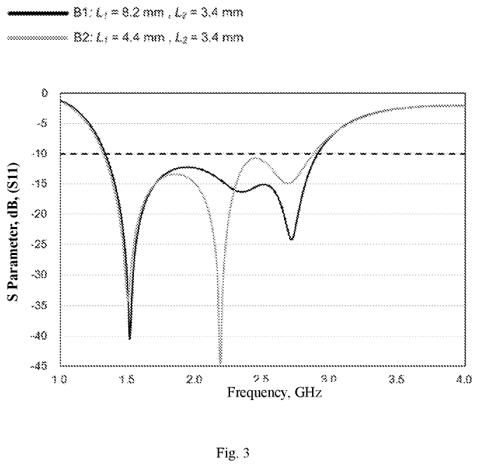

With L1=8.2 mm and L2=3.4 mm for antenna B1, and L1=4.4 mm and L2=3.4 mm for antenna B2, FIG. 3 gives the simulation results of antenna B1 and antenna B2. It can be seen that changing the length of L1 makes the length (Lₗₒₒₚ) of the cavity 31 different, and the feedback loss of the antenna, i.e., the resonance frequency, is also different. The lower is the length (Lₗₒₒₚ), the higher is the antenna frequency. According to the principle, broadband antennas with different lengths may be fabricated for use in products requiring different operating frequencies.

TABLE 1
Sizes of antennas with different cavity lengths

| Antenna | L₁ | L₂ |
|---|---|---|
| A1 | 3.4 | 9.8 |
| A2 | 3.4 | 8.2 |
| B1 | 8.2 | 3.4 |
| B2 | 4.4 | 3.4 |

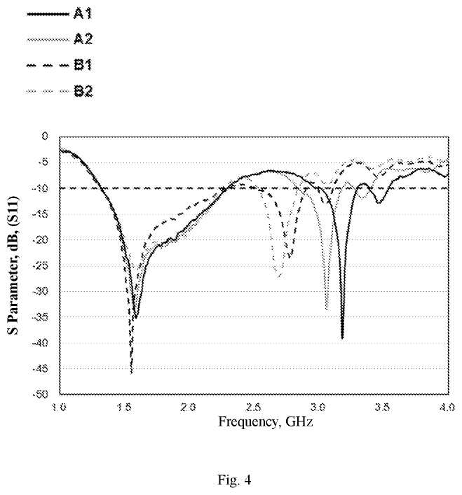

FIG. 4 shows the test results of antennas A1, A2, B1, and B2. It can be seen that the loop antenna of the present invention, by adjusting the lengths of L1 and L2, obtains different operating frequencies, and meets the use of different antenna products. In addition, since there is no LTE spectrum at 2.6-3.3 GHz, the present invention is able to support a spectrum system in 1.5-2.6 GHz by adjusting L1 and L2, and may also support a higher LTE spectrum at 3.3-3.9 GHz.

For those skilled in the art, apparently the present invention is not limited to the details given in the above exemplary embodiments. The present invention can be embodied in other specific forms without departing from the spirit or essential characteristics of the invention. Therefore, the embodiments shall be considered as exemplary and unrestricted in any way. The scope of the invention is defined by the appended claims rather than the above description. Hence, all changes intended to come within the meaning and range of equivalent elements of the claims shall be included within the invention. Any marks on drawings to the Claims shall not be construed as limiting the Claims involved.

Furthermore, it shall be understood that although the Specification is described in terms of embodiments, not every embodiment includes only one independent technical scheme. The description style in the Specification is for clarity only. Those skilled in the art shall take the Specification as a whole. The technical schemes in various embodiments may also be combined as appropriate to form other embodiments that can be understood by those skilled in the art.

1. A planar loop antenna, its applications and application methods, comprising a PCB, a ground plane and a plane antenna, wherein the ground plane and the plane antenna are fixed on the PCB, which is characterized in that a rectangular cavity is disposed in the center of the plane antenna.

2. A planar loop antenna according to claim 1, its applications and application methods, wherein an electronic circuit is disposed at the bottom of the ground plane.

3. A planar loop antenna according to claim 1, its applications and application methods, wherein the distance between the plane antenna and the PCB is 1 mm.

4. A planar loop antenna according to claim 1, its applications and application methods, as well as its applications in LTE communication in 3.3 to 3.9 GHz band, and in Bluetooth communication.

5. Application methods of a planar loop antenna according to claim 4, which are characterized in that different antenna operating frequencies are obtained by adjusting the distance between the short side of the cavity and the plane antenna.
